(19) United States
(12) Patent Application Publication
(10) Pub. No.: US 2016/0324088 A1
(43) Pub. Date: Nov. 10, 2016

(54) KIT FOR CULTIVATING SPROUT GARLIC

(71) Applicant: MIRAKHL Co., Ltd., Seoul (KR)

(72) Inventor: Jung Sun KIM, Seoul (KR)

(21) Appl. No.: 15/214,396

(22) Filed: Jul. 19, 2016

Related U.S. Application Data
(63) Continuation of application No. PCT/KR2015/006013, filed on Jun. 15, 2015.

(30) Foreign Application Priority Data
Apr. 24, 2015 (KR) 10-2015-0058175

(51) Int. Cl. A01G 31/02

(52) U.S. Cl. CPC A01G 31/02; A01G 2031/006

(57) ABSTRACT

The present disclosure relates to a kit for cultivating sprout garlic. The kit for cultivating sprout garlic includes an upper lid cover comprising at least one port having a space configured to cultivate the sprout garlic; a lower tray comprising a nutrient solution keeping chamber configured to soak a predetermined part of the at least one port into nutrient solution when the lower tray is coupled to the upper lid cover, wherein the sprout garlic is introduced into the at least one port; and a nutrient solution purifying filter and a nutrient solution circulating pump provided in a space formed between lower end parts of the nutrient solution keeping chamber and the lower tray, wherein the nutrient solution introduced into the nutrient solution keeping chamber is purified through the nutrient solution purifying filter and the nutrient solution circulating pump at a predetermined time period.

### CROSS-REFERENCE TO RELATED APPLICATIONS

The present application is a continuation of International Patent Application No. PCT/KR2015/006013, filed Jun. 15, 2015, which is based upon and claims the benefit of priority to Korea Patent Application No. 10-2015-0058175, filed on Apr. 24, 2015. The disclosures of the above-listed applications are hereby incorporated by reference herein in their entirety.

### TECHNICAL FIELD

Embodiments of the inventive concept described herein relate to a kit for cultivating sprout garlic, and more particularly, relate to a kit for cultivating sprout garlic, which may be used to culture sprout garlic and may purify a culture medium used for water-culturing sprout garlic.

### BACKGROUND ART

In recent years, as the number of people returning to farming or agricultural villages is increased, a culture method different from a conventional soil cultivation method has been introduced in terms of a plant cultivation method.

In detail, a plant cultivation method according to the related art, especially a sprout garlic cultivation method is mainly performed through a soil cultivation method by which sprout garlic is cultivated in soil, but in recent years, a new water culture method that cultures sprout garlic by using a culture medium prepared with water and water soluble nutrients differently from the soil cultivation method has been introduced.

In case of cultivation of sprout garlic in a solid cultivation method according to the related art, due to overuse of chemical fertilizer, environment destruction such as soil pollution is caused. Such environment destruction is the root of a vicious circle of environment pollution that causes soil eutrophication, water pollution and ultimately, air pollution.

Although a new water culture method is introduced to solve the problems described above, even the recently introduced water culture methods are mostly performed together with soil fertilization and using of artificial soil. Even if not so, due to the previously used culture medium, environment pollution is still caused so that the problems described above are not fully solved yet.

In detail, when sprout garlic is cultured by using a water culture method, about 95% of the cultivators using the water culture method do not reuse the culture medium used for the water culture method, so that solid and rivers are polluted due to the indiscreet discharge of the used culture medium. In addition, after discharging the culture medium, a cultivator cannot help purchasing a new culture medium, fertilizer and the like, so that the increase of the cost is newly caused.

In addition, when any solid cultivation is not combined in cultivating sprout garlic, a sponge for water culture is generally used. When a sponge for water culture is used, the roots of root vegetable such as sprout garlic only grows in the sponge for water culture, so that it may be impossible to harvest the roots and in addition, another waste of a disposable sponge may be generated.

In advance, when sprout garlic is cultured by using a water culture method, since the culture medium must be frequently changed, there is required to continuously manage the culture medium. Conventionally, the sprout garlic has a long growing period of about two weeks or more. Thus, due to the inconvenience in culture and the long growing period, it is difficult for most people to smoothly perform the continuous management in their busy lives.

Thus, there is required to provide a scheme for solving the problems described above.

### DISCLOSURE

### Technical Problem

An object of the inventive concept is to provide a kit for cultivating sprout garlic by which the problems described above may be solved.

Another object of the inventive concept is to provide a kit for cultivating sprout garlic, which includes a nutrient solution purifying filter and nutrient solution circulating pump to purify nutrient solution such that the number of managing nutrient solution may be minimized and the nutrient solution may be reused.

Still another object of the inventive concept is to provide a kit for cultivating sprout garlic, which includes a port having a through-hole such that a root part of the sprout garlic which is a root vegetable is harvestable.

Still another object of the inventive concept is to provide a kit for cultivating sprout garlic, which is capable of cultivating sprout garlic by soaking the sprout garlic germinated in accordance with a method predetermined for reducing a growing period.

Still another object of the inventive concept is to provide a kit for cultivating sprout garlic, which is connected to an application of a terminal to transmit/receive data on the sprout garlic and remotely manage the sprout garlic in cultivation.

Technical tasks obtainable from the embodiments of the inventive concept may be non-limited by the above mentioned technical tasks. And, other unmentioned technical tasks can be clearly understood from the following description by those having ordinary skill in the technical field to which the embodiments of the inventive concept pertain.

### Technical Solution

To solve the problems, according to an embodiment, there is provided a kit for cultivating sprout garlic, which includes: an upper lid cover including at least one port having a space configured to cultivate the sprout garlic; a lower tray including a nutrient solution keeping chamber configured to soak a predetermined part of the at least one port into nutrient solution when the lower tray is coupled to the upper lid cover, wherein the sprout garlic is introduced into the at least one port; and a nutrient solution purifying filter and a nutrient solution circulating pump provided in a space formed between lower end parts of the nutrient solution keeping chamber and the lower tray, wherein the nutrient solution introduced into the nutrient solution keeping chamber is purified through the nutrient solution purifying filter and the nutrient solution circulating pump at a predetermined time period.

In the kit for cultivating sprout garlic according to an embodiment of the inventive concept, the cultivation of the sprout garlic may be performed by using a water culture method.

In the kit for cultivating sprout garlic according to an embodiment of the inventive concept, the water culture may be performed while the sprout garlic germinated in accordance with a predetermined method is introduced into the at least one port.

In the kit for cultivating sprout garlic according to an embodiment of the inventive concept, the at least one port may be formed in a lower end part thereof with a through-hole through which a root of the sprout garlic grows.

In the kit for cultivating sprout garlic according to an embodiment of the inventive concept, the nutrient solution keeping chamber may be formed at a lower end part thereof with a check valve, and the nutrient solution introduced into the nutrient solution keeping chamber flows toward the nutrient solution purifying filter only in the lower end part of the nutrient solution keeping chamber by the check valve.

In the kit for cultivating sprout garlic according to an embodiment of the inventive concept, the lower tray may further include a drain formed at one side thereof.

In the kit for cultivating sprout garlic according to an embodiment of the inventive concept, the lower tray may further include an opening/closing part formed at one end of the lower tray to approach the space.

In the kit for cultivating sprout garlic according to an embodiment of the inventive concept, the nutrient solution may include a culture medium generated by applying a predetermined process to solution including a mineral extracted from mica, and the process may include at least one of a filtering process and a diluting process.

The kit for cultivating sprout garlic according to an embodiment of the inventive concept may further include a wireless communication unit configured to transmit data to at least one external device; and a sensing unit configured to measure a length value of a growth of the sprout garlic, wherein the length value measured by the sensing unit is transmitted to an application of a terminal interworking with the wireless communication unit.

In the kit for cultivating sprout garlic according to an embodiment of the inventive concept, the application may display information about the received length value and information about the method of cultivating sprout garlic on the terminal, and the application may receive a review of the sprout garlic cultivation from a user of the terminal and transmits information about the received cultivation review to at least one external device.

### Advantageous Effects

According to the embodiments of the inventive concept, the advantageous effects described below may be obtained. However, the advantageous effects obtainable through the embodiments are not limited to them mentioned below.

First, according to the embodiments, the kit for cultivating sprout garlic may be provided.

Second, according to the embodiments, the kit for cultivating sprout garlic includes a nutrient solution purifying filter and nutrient solution circulating pump to purify nutrient solution such that the number of managing nutrient solution may be minimized and the nutrient solution may be reused, thereby improving the convenience in management and reducing environment pollution.

Third, according to the embodiments, the kit for cultivating sprout garlic includes a port having a through-hole such that a root part of the sprout garlic which is a root vegetable is harvestable.

Fourth, according to the embodiments, the kit for cultivating sprout garlic may cultivate sprout garlic by soaking the sprout garlic germinated in accordance with a predetermined method, thereby reducing a growing period.

Fifth, according to the embodiments, the kit for cultivating sprout garlic, which may be connected to an application of a terminal to transmit/receive data on the sprout garlic and to remotely manage the sprout garlic in cultivation.

The effects of the embodiments are not limited to the above-described effects and other effects which are not described herein will be understood by those skilled in the art from the following description of the embodiments.

### DESCRIPTION OF DRAWINGS

FIG. 1 is a view illustrating a kit for cultivating sprout garlic according to an embodiment.

FIG. 2 is a view illustrating an upper lid cover and a port of a kit for cultivating sprout garlic according to an embodiment.

FIG. 3 is a view illustrating a wireless communication system to which a kit for cultivating sprout garlic is applied according to an embodiment.

FIG. 4 is a signaling chart illustrating a process of transmitting/receiving data on sprout garlic between a kit for cultivating sprout garlic and an application of an interworking terminal according to an embodiment.

### BEST MODE

### Mode for Invention

Embodiments will now be described in detail with reference to the accompanying drawings. The detailed description which will be disclosed with reference to the accompanying drawings is to describe embodiments, but is not to represent a unique embodiment.

Rather, these embodiments are provided so that this disclosure will be thorough and complete and will fully convey the concept of the invention to those skilled in the art, and the present invention will only be defined by the appended claims.

In some cases, to prevent the concept of the embodiment from being ambiguous, structures and apparatuses of the known art will be omitted, or will be shown in the form of a block diagram based on main functions of each structure and apparatus. The same reference numerals will be used throughout to designate the same or like elements.

When it is said that a part ‘comprises’ or ‘includes’ a component through the specification, this means that unless otherwise specified, the part may further include another component, not excluding another component.

In addition, the term ‘unit’ signifies a unit of processing at least one function or operation. This may be implemented in hardware, software, or a combination of them. Further, ‘a’ or ‘an’, ‘one’, and their similar terms may include both singular and plural expressions, unless otherwise specified or clearly indicated in the context of the embodiments.

Unless defined differently, all terms used herein, which include technical terminologies or scientific terminologies, have the same meaning as that understood by a person skilled in the art to which the present disclosure belongs and are provided to help a person skilled in the an to easily understand the inventive concept. Such terms as those defined in a generally used dictionary are to be interpreted to have the meanings equal to the contextual meanings in the relevant field of art, and are not to be interpreted to have ideal or excessively formal meanings unless clearly defined in the present specification

Hereinafter, the preferred embodiments will be described with reference to the accompanying drawings. It is to be understood that the detailed description, which will be disclosed along with the accompanying drawings, is intended to describe the embodiments, and is not intended to describe a unique embodiment which can be carried out.

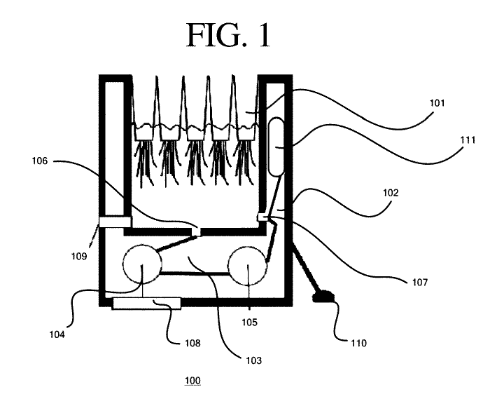

FIG. 1 is a view illustrating a kit for cultivating sprout garlic according to an embodiment.

Referring to FIG. 1, a kit for cultivating sprout garlic 100 according to an embodiment may include at least one port 101 having a space for cultivating the sprout garlic, a lower tray 102 including a nutrient solution keeping chamber for soaking a predetermined part of the at least one port into nutrient solution, and a nutrient solution purifying filter 104 and a nutrient solution circulating pump 105 provided in a space 103 formed between lower end parts of the nutrient solution keeping chamber and the lower tray 102.

Although the kit 100 for cultivating sprout garlic, which will be described below, includes at least one of the elements 101 to 104 described above, the embodiment is not limited thereto and as described above, additional elements may be further included.

Meanwhile, the cultivation of sprout garlic in the kit 100 for cultivating sprout garlic according to an embodiment may be performed by using a water culture method.

In detail, the water culture method is a method that cultivates sprout garlic by using a culture medium prepared with water and water soluble nutrients. When compared with a soil cultivation method, the water culture method has no inconvenience of periodically changing soil and may prevent the damages caused due to microorganisms living in soil and disease and insect pests.

Referring to FIG. 1 again, the kit 100 for cultivating sprout garlic according to an embodiment may include at least one port 101 having a space for cultivating the sprout garlic.

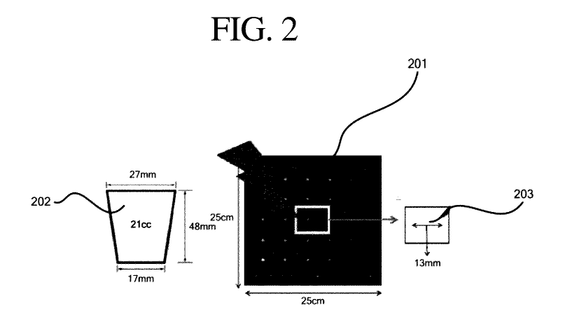

In this case, the at least one port 101 may be formed in the upper lid cover 201 depicted in FIG. 2. In addition, the at least one port may be implemented at a size and length 202 shown in FIG. 2, but this is proposed only as one example. The at least one port may be implemented at a size and length different from those 202 shown in FIG. 2.

Meanwhile, pieces of sprout garlic may be placed in the at least one port 101, respectively. The sprout garlic led into the port 101 may be placed at a lower end part of the port 101.

In this case, according to an embodiment, as shown in FIG. 2, a through-hole 203 may be formed in the lower end portion of each port 101 to allow the root of sprout garlic to grow. A diameter of the through-hole 203 may be predetermined to be smaller than a size of the sprout garlic.

As described above, when the though-hole is formed in the lower end portion of the port 101 in which the sprout garlic is placed and grows, the root of sprout garlic of which the length is increased in proportion to the growth of sprout garlic may continuously grows through the through-hole, so that the root of the sprout garlic which a root plant may be obtained.

That is, in case of a water culture device according to the related art, differently from the kit having the port formed with the through-hole according to an embodiment, the device generally includes a sponge which absorbs nutrient solution, such that nutriment of the nutrient solution is provided to the sprout garlic to cultivate the sprout garlic.

In this case, as the root of sprout garlic grows, since the root cannot help passing through the sponge, a root part of the sprout garlic is coupled to the sponge at the time when the growth of sprout garlic is completed, so that it is difficult to collect the root of sprout garlic.

However, since the kit 100 for cultivating sprout garlic according to an embodiment includes at least one port 101 provided with the space for cultivating sprout garlic and in addition, having the through-hole, the root of sprout garlic rooted out grows while passing through the through-hole, so that the root of sprout garlic may be entirely collected when the growth of sprout garlic is later completed.

Referring to FIG. 1 again, the kit 100 for cultivating sprout garlic includes the lower tray 102 which includes a nutrient solution keeping chamber for soaking a predetermined part of the port 101 into nutrient solution.

When sprout garlic is cultivated through a water culture method, the nutrient solution keeping chamber in the lower tray 102 has a space having a predetermined size which can store and keep nutrient solution therein

In this case, according to an embodiment, a predetermined amount of nutrient solution may be stored or kept in the nutrient solution keeping chamber, where the predetermined amount represents an amount sufficient to soak the lower end portion of the port 101 therein.

That is, as shown in FIG. 1, since each port 101 in which sprout garlic is placed is included in the upper lid cover, when the upper lid cover is coupled to the lower tray 102, the port 101 containing sprout garlic may be inserted into the nutrient solution keeping chamber in the lower tray 102.

In this case, since the culture solution may be stored and kept in the nutrient solution keeping chamber, each lower end portion of the at least one port 1101 inserted into the nutrient solution keeping chamber may be soaked into the nutrient solution kept in the nutrient solution keeping chamber.

In this case, since the sprout garlic is placed in the lower end portion of the port 101 inserted into the nutrient solution keeping chamber, due to the soaking of the port 101, the sprout garlic in the port 101 may be also soaked in the nutrient solution.

Thereafter, when the sprout garlic roots, the root of sprout garlic may sufficiently absorb nutritive components of the nutrient solution so that the sprout garlic and root thereof may grow better.

According to an embodiment, the nutrient solution stored and kept in the nutrient solution keeping chamber may be a culture medium prepared by applying a predetermined process to solution including minerals extracted from mica. The predetermined process may include at least one of a filtering process and a diluting process.

In addition, according to an embodiment, the sprout garlic may be germinated in accordance with a predetermined method. As described above, when the sprout garlic germinated beforehand through a pretreatment process is cultivated by using the kit 100 for cultivating sprout garlic, the growing period of 5 days is taken greatly shortened as compared with a general growing period of two weeks. Thus, the problem that the management of a cultivator and the concentration of cultivation are deteriorated as the growing period is increased may be solved.

Meanwhile, in general, when the sprout garlic is cultivated in accordance with a water culture method, the nutrient solution must be periodically changed. In addition, a device for water culture must be periodically washed. If not so, the nutrient solution may be spoiled to stink, or the spoiled nutrient solution may exert a had influence on the growth of sprout garlic.

However, since the periodic changing of the nutrient solution or the washing of the water culture device gives annoyance and inconvenience to a sprout garlic cultivator, most of cultivators frequently omit or ignore those works.

Thus, according to an embodiment, as shown in FIG. 1, the kit 100 for cultivating sprout garlic may include a space 103 formed between the lower end portions of the nutrient solution keeping chamber and the lower tray 102. The nutrient solution purifying filter 104 and the nutrient solution circulating pump 105 may be formed in the space 103.

That is, according to the kit 100 for cultivating sprout garlic of an embodiment, the nutrient solution purifying filter 104 and the nutrient solution circulating pump 105 may be formed in the space 103 provided between the lower end portions of the nutrient solution keeping chamber and the lower tray 102. The nutrient solution purifying filter 104 and the nutrient solution circulating pump 105 are configured to purify the nutrient solution in the nutrient solution keeping chamber, so that the nutrient solution stored and kept in the nutrient solution keeping chamber may be purified through the nutrient solution purifying filter 104 and the nutrient solution circulating pump 105 at a predetermined time period.

In detail, the nutrient solution stored and kept in the nutrient solution keeping chamber may flow only toward the nutrient solution purifying filter 104 by the check valve 106 formed at the lower end part of the nutrient solution keeping chamber.

Thus, the nutrient solution stored and kept in the nutrient solution keeping chamber may pass through the check valve 106 and flow to the nutrient solution purifying filter 104, so that the nutrient solution purifying filter 104 may purify the flowing nutrient solution.

In this case, the nutrient solution purifying filter 104 may be implemented in a filter or cartridge type. The filter may include a UF hollow fiber filter, an active carbon filter, an RO reverse osmotic pressure filter, etc., but these filters are proposed as examples and all types of purifying filters or cartridges currently under development or to be developed may be included.

Meanwhile, the nutrient solution purified through the nutrient solution purifying filter 104 may flow into the nutrient solution circulating pump 105, so that the nutrient solution may flow into the nutrient solution keeping chamber through the pumping operation of the nutrient solution circulating pump 105 again.

In this case, another check valve 107 for preventing the nutrient solution from flowing backward may be further provided between the nutrient solution keeping chamber and the nutrient solution circulating pump 105. The nutrient solution purified by the check valve 107 may flow only toward the nutrient solution keeping chamber.

The nutrient solution flow and the nutrient solution purifying process of the kit 100 for cultivating sprout garlic according to an embodiment may be performed at the predetermined time period, so that the number of supplying new nutrient solution or washing the cultivation kit may be reduced, thereby greatly reducing the decay rate of the nutrient solution in the nutrient solution keeping chamber and improving the convenience of a user.

In detail, about 95% of the cultivators using a water culture method do not generally reuse the nutrient solution or culture medium used for the water culture method, so that the used nutrient solution or culture medium is indiscreetly discharged, thereby polluting soil and rivers. After discharging the culture medium or nutrient solution, a cultivator cannot help purchasing a new culture medium or nutrient solution, so that the cost may be increased. However, according to an embodiment, as described above, since the kit 100 for cultivating sprout garlic, which includes the nutrient solution purifying filter 104 and the nutrient solution circulating pump 105, performs the nutrient solution flow and the nutrient solution purifying process at the predetermined time period, the nutrient solution may be reused, so that the environment pollution and the cost may be ultimately reduced.

Meanwhile, the kit 100 for cultivating sprout garlic according to an embodiment may further include a nutrient solution supply device 111 capable of supplying the nutrient solution to the nutrient solution keeping chamber. In case that, as described above, the nutrient solution flow and the nutrient solution purifying process are performed by the nutrient solution purifying filter 104 and the nutrient solution circulating pump 105 at the predetermined time period, as the flow and purifying are repeated, the nutrients of the nutrient solution flowing into the nutrient solution keeping chamber may be relatively reduced when compared with the initial nutrient solution before being purified. According to an embodiment, since the nutrient solution supply device 111 of the kit 100 for cultivating sprout garlic supplies the new nutrient solution and purified nutrient solution together to the nutrient solution keeping chamber, even when the nutrient solution is not periodically changed, a predetermined amount of nutrients may be continuously supplied to sprout garlic.

Thus, according to the kit 100 for cultivating sprout garlic of an embodiment, the number of changing the nutrient solution may be greatly reduced, so that the user convenience may be more improved.

Meanwhile, the kit 100 for cultivating sprout garlic according to an embodiment may further include a drain 109 provided on one end of the lower tray 102.

Thus, the nutrient solution kept in the nutrient solution keeping chamber may be removed manually by a cultivator. After the nutrient solution kept in the nutrient solution keeping chamber is fully removed, the washing of the kit 100 for cultivating sprout garlic may be performed.

After all the nutrient solution kept in the nutrient solution keeping chamber is removed, new nutrient solution may be supplied to the nutrient solution keeping chamber through the nutrient solution supply device 111, so that the embodiments described above may be repeatedly implemented.

In addition, the lower tray 102 of the kit 100 for cultivating sprout garlic according to an embodiment may include an opening/closing part 108 formed at one side of the lower tray 102 to approach the space 103.

Thus, a cultivator, who cultivates sprout garlic using the kit 100 for cultivating sprout garlic, may directly approach to the nutrient solution purifying filter 104 and the nutrient solution circulating pump 105 formed in the space 103, so that the cultivator may change the nutrient solution purifying filter 104 or adjust the pumping number or a pumped amount of nutrient solution per unit of time of the nutrient solution circulating pump 105.

The kit 100 for cultivating sprout garlic according to an embodiment may include a power supply line 110 such that an amount of power required to smoothly operate each component of the kit 100 for cultivating sprout garlic may be continuously supplied.

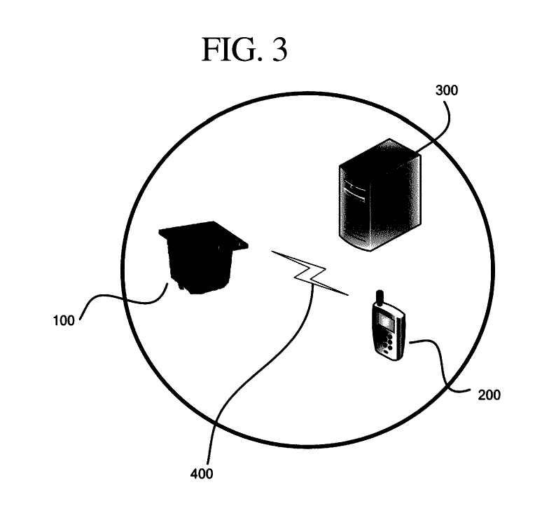

FIG. 3 is a view illustrating a wireless communication system to which a kit for cultivating sprout garlic is applied according to an embodiment.

Referring to FIG. 3, a wireless communication system applicable to the embodiments may include a kit 100 for cultivating sprout garlic, a terminal 200, a server 300, and a network 400.

However, the wireless communication system described below includes at least one of components shown in FIG. 3, but the embodiment is not limited thereto. In addition, although one kit for cultivating sprout garlic, one terminal, one server, and one network are shown in FIG. 3, another wireless communication system applicable to the embodiments may include at least one kit for cultivating sprout garlic, at least one terminal, at least one server, and at least one network. The kit for cultivating sprout garlic, the terminal, and the server may be connected to each other through ally different networks.

According to an embodiment, the kit 100 for cultivating sprout garlic may measure a value of a growth length of sprout garlic and may transmit the measured length value to at least one external device (such as a terminal or a server). In this case, the kit 100 for cultivating sprout garlic may further include a sensing unit for measuring the value of the growth length of the sprout garlic.

The sensing unit may generate a sensing signal for measuring a root length of sprout garlic. The sensing unit may include all sensors which have been developed and will be developed in future.

For example, the sensing unit may include a motion sensor or a proximity sensor. The motion sensor measures the length by directly sensing a location and movement of the root, and the proximity sensor measures the length of a growing root without any mechanical contacts.

Meanwhile, in case of the terminal 200 receiving the measured length value from the kit 100 for cultivating sprout garlic, at least one application may be previously installed in the terminal 200.

In this case, for example, the terminal 200 may include a terminal, MS (Mobile Station), MSS (Mobile Subscriber Station), SS (Subscriber Station), AMS (Advanced Mobile Station), WT (Wireless terminal), MTC (Machine-Type Communication) device, M2M (Machine-to-Machine) device, D2D (Device-to-Device), etc. Of course, these are just examples and the terminal 200 should be analyzed as a concept including all devices capable of transmitting data which have been developed and commercialized at present and will be developed in future in addition to the aforementioned examples.

The server 300 may represent a subject capable of transmitting/receiving data through wireless communication network. The server 300 may represent a device receiving information about a cultivation review input through the terminal 200 by a user of the kit 100 for cultivating sprout garlic.

In addition, for example, the server 300 may include a cloud server, IMS (IP Multimedia Subsystem) server, a telephony application server, IM (Instant Messaging) server, MGCF (Media Gateway Control Function) server, MSG (Messaging Gateway) server, CSCF (Call Session Control Function) server, etc. The server 300 may be implemented with a device, such as PC (Personal Computer), a laptop computer or a tablet PC, which is represented as a subject capable of transmitting/receiving data

Meanwhile, the network 400 represents a data communication network for transmission and reception between the kit 100 for cultivating sprout garlic, the terminal 200 and the server 300, but the embodiment is not limited to a specific type of a network. For example, the network 400 may be IP (Internet Protocol) network for serving the transmission/reception of a large quantity of data or an all IP network in which mutually different IP networks are combined with each other.

In addition, the network 400 may be one of a mobile communication network including a wire communication network, Wibro (Wireless Broadband) network and WCDMA, a mobile communication network including an HSDPA (High Speed Downlink Packet Access) network, a mobile communication network including an LTE (Long Term Evolution) network, a mobile communication network including LTE advanced (LTE-A), a satellite communication network, and an Wi-Fi network, or the combination thereof.

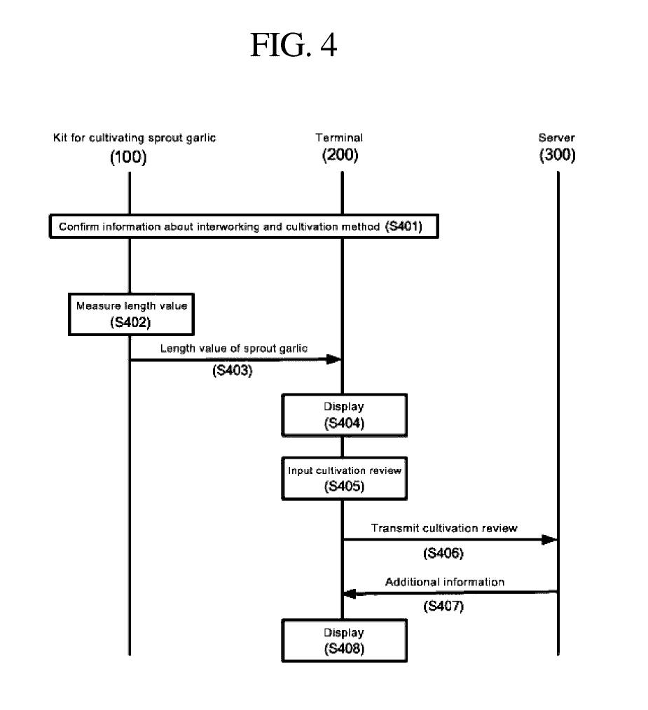

FIG. 4 is a signaling chart illustrating a process of transmitting/receiving data on sprout garlic between a kit for cultivating sprout garlic and an application of an interworking terminal according to an embodiment.

Referring to FIG. 4, according to an embodiment, there exist a kit 100 for cultivating sprout garlic, a terminal 200, and a server 300. In step S401, the kit 100 for cultivating sprout garlic and the terminal 200 may previously interwork with each other.

In this case, the interworking may represent the wireless communication connection establishment between the kit 100 for cultivating sprout garlic and the terminal 200 by completing a random access procedure between the kit 100 for cultivating sprout garlic and the terminal 200. The connection establishment may be a concept including a wireless communication connection between applications previously installed in the kit 100 for cultivating sprout garlic and the terminal.

Meanwhile, according to an embodiment, a cultivator using the kit 100 for cultivating sprout garlic may confirm information about a sprout garlic cultivation method by using the application installed in the interworking terminal 200, so that the sprout garlic cultivation may be more easily performed by using the kit 100 for cultivating sprout garlic.

The information about a sprout garlic cultivation method may include information required to cultivate sprout garlic such as a process of growing sprout garlic or a changing period of nutrient solution. Differently from the above, the information may further include a description about names, effects and other cultivation methods of cultivatable crops and plants as well as sprout garlic, where the information about the sprout garlic cultivation method is previously received from the server 300 or other external devices and stored in the terminal 200.

Meanwhile, after confirming the information about a sprout garlic cultivation method through the application in the terminal 200, the cultivator may cultivate sprout garlic using the kit 100 for cultivating sprout garlic.

Then, in step S402, when the sprout garlic roots and grows, the sensing unit in the kit 100 for cultivating sprout garlic may measure the value of a growth length of the sprout garlic.

In step S403, the measured length value may be transmitted to the application of the terminal 200. The cultivator may confirm the measured length value received through a display of the terminal 200 in step S404. Thus, since the cultivator may visually confirm how much the sprout garlic cultivated by using the kit 100 for cultivating sprout garlic grows, the cultivator may cultivate the sprout garlic while having continuous interest in the cultivation.

Although not shown in FIG. 4, after confirming the received measured length value, the cultivator may confirm the period of changing the nutrient solution purifying filter of the kit 100 for cultivating sprout garlic through the application of the terminal 200. In addition, the cultivator may input a control instruction of controlling the pumping number or a pumped amount of nutrient solution per unit of time of the nutrient solution circulating pump, such that the nutrient solution circulating pump of the kit 100 for cultivating sprout garlic is controlled in accordance with the control instruction input by the cultivator.

Meanwhile, when the sprout garlic fully grows, the cultivator may input a cultivation review of the sprout garlic through the application of the terminal 200 in step S405. The data including the cultivation review input from the cultivator may be transmitted to an external server 300.

At this time, in step S407, the terminal 200 may receive additional information as a response message to the data including the cultivation review transmitted from the external server 300. The additional information may further include information about the growing process and steps of other cultivators or about cultivation reviews transmitted from other cultivators to the server.

Meanwhile, in step S408, the additional information received from the server 300 may be stored in a memory of the terminal 200, such that the user of the terminal 200 confirms the additional information through the display. Even though the cultivation review is not transmitted in step S405, the additional information may be immediately received from the server 300 through the application previously installed in the terminal 200.

Meanwhile, the wireless communication unit included in the kit 100 for cultivating sprout garlic may include a transmitter and a receiver. The transmitter and the receiver may be used to transmit and receive data or a signal to/from the terminal 200 or the server 300.

Although not shown in FIGS. 1 to 4, the kit 100 for cultivating sprout garlic may further include a controller. The controller may be functionally connected to the transmitter and the receiver of the wireless communication unit to control such that the process of transmitting/receiving data or a signal to/from the terminal 200 or the server 300. In addition, after performing various kinds of processes of the data to be transmitted, the controller may transmit the data to the transmitter. In addition, the controller may perform a process of received data by the receiver

If necessary, the controller may store the information included in the exchanged data in the memory. The kit 100 for cultivating sprout garlic configured as above may be implemented in various forms of the embodiments previously described with reference to FIGS. 1 to 4.

In addition, as described above, the terminal 200 according to an embodiment may include a display configured to display in real time information about a length value of sprout garlic, a sprout garlic cultivation method, a cultivation review of sprout garlic, or the like.

The display may display information processed by the terminal 200. For example, the information may be displayed in a form of UI (User Interface) or GUI (Graphic User Interface).

In addition, the display may include at least one of an LCD (Liquid Crystal Display), a thin film transistor-liquid crystal display, an organic light-emitting diode, a flexible display, and a three-dimensional (3D) display. At least two displays may be provided in accordance with an implementation form. For example, external and internal displays may be provided to the terminal 200 at the same time.

As well as the kit 100 for cultivating sprout garlic, the terminal 200 and the server 300 may further include controllers, respectively. The controllers instruct the operations of the kit 100 for cultivating sprout garlic, the terminal 200 and the server 300 (for example, control, adjustment, management, etc.). The controllers may be connected to memories capable of storing program codes and data. Each memory may store an operating system, an application, and general files.

The controller according to an embodiment may be referred to as a processor, a controller, a microprocessor, a microcomputer or the like. Meanwhile, the controller may be implemented by hardware, firmware, software, or a combination thereof.

In case that the embodiment is implemented by firmware or software, the embodiment may be implemented in the form of modules, processes, functions, or the like which perform the features or operations described above. Software codes may be stored in a memory to be executed by a processor. The memory may be located inside or outside the kit 100 for cultivating sprout garlic, the terminal 200 and the server 300 and may communicate data with the processor through known various means.

While the inventive concept has been described with reference to embodiments, it will be apparent to those skilled in the an that various changes and modifications may be made without departing from the spirit and scope of the inventive concept. Therefore, it should be understood that the above embodiments are not limiting, but illustrative.

### INDUSTRIAL APPLICABILITY

A kit for cultivating sprout garlic according to the inventive concept may be applied to various devices or kits capable of cultivating sprout garlic.

What is claimed is:

1. A kit for cultivating sprout garlic, the kit comprising:
an upper lid cover comprising at least one port having a space configured to cultivate the sprout garlic;
a lower tray comprising a nutrient solution keeping chamber configured to soak a predetermined part of the at least one port into nutrient solution when the lower tray is coupled to the upper lid cover, wherein the sprout garlic is introduced into the at least one port; and
a nutrient solution purifying filter and a nutrient solution circulating pump provided in a space formed between lower end parts of the nutrient solution keeping chamber and the lower tray,
wherein the nutrient solution introduced into the nutrient solution keeping chamber is purified through the nutrient solution purifying filter and the nutrient solution circulating pump at a predetermined time period.

2. The kit of claim 1, wherein the cultivation of the sprout garlic is performed by using a water culture method.

3. The kit of claim 2, wherein the water culture is performed while the sprout garlic germinated in accordance with a predetermined method is introduced into the at least one port.

4. The kit of claim 3, wherein the at least one port is formed in a lower end part thereof with a through-hole through which a root of the sprout garlic grows.

5. The kit of claim 1, wherein the nutrient solution keeping chamber is formed at a lower end part thereof with a check valve, and
the nutrient solution introduced into the nutrient solution keeping chamber flows toward the nutrient solution purifying filter in the lower end part of the nutrient solution keeping chamber by the check valve.

6. The kit of claim 1, wherein the lower tray further comprises a drain formed at one side thereof.

7. The kit of claim 1, wherein the lower tray further comprises an opening/closing part formed at one end of the lower tray to approach the space.

8. The kit of claim 1, wherein the nutrient solution comprises a culture medium generated by applying a predetermined process to solution comprising a mineral extracted from mica, and
the process comprises at least one of a filtering process and a diluting process.

9. The kit of claim 1, further comprising a wireless communication unit configured to transmit data to at least one external device; and
a sensing unit configured to measure a length value of a growth of the sprout garlic,
wherein the length value measured by the sensing unit is transmitted to an application of a terminal interworking with the wireless communication unit.

10. The kit of claim 9, wherein the application displays information about the received length value and information about the method of cultivating sprout garlic on the terminal, and
the application receives a review of the sprout garlic cultivation from a user of the terminal and transmits information about the received cultivation review to at least one external device.
